(19) United States
(12) Patent Application Publication
(10) Pub. No.: US 2006/0050084 A1
(43) Pub. Date: Mar. 9, 2006

(54) Apparatus and method for histogram stretching

(76) Inventors: Eric Jeffrey, Richmond (CA); Barinder Singh Rai, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/934,957

(22) Filed: Sep. 3, 2004

(51) Int. Cl. G09G 5/00

(52) U.S. Cl. 345/617

(57) ABSTRACT

A graphics controller including a memory and a contrast adjustment module is provided to perform on-board histogram stretching. The memory is configured to store a histogram table for a digital image. The contrast adjustment module is configured to read the histogram table stored in the memory and compute a histogram stretching transfer function based on the read histogram table. The contrast adjustment module is further configured to apply the computed histogram stretching transfer function to digital image data to be subsequently received by the contrast adjustment module.

### BACKGROUND OF THE INVENTION

1. Field of the Invention

The present invention relates generally to display of digital image data.

2. Description of the Related Art

Contrast within an image, such as that captured by a digital camera, can often need improvement. If the image has insufficient contrast, features and details of the image may be indistinguishable from other portions of the image. Therefore, evaluation and adjustment of the image contrast may be useful prior to display.

One method for evaluating the contrast of the image includes generating a histogram table for the image. The histogram table represents a frequency of occurrence of each pixel value within the image. Therefore, evaluation of the histogram table can identify similar pixel values that occur with sufficient frequency in the image such that contrast is adversely affected. Using the information gleaned from the histogram table, the image can be appropriately refined to improve contrast prior to display of the image. A continuing need exists for improvement of the methods and apparatuses for using the histogram table to refine the image to improve contrast.

### SUMMARY OF THE INVENTION

In one embodiment, a graphics controller is disclosed. The graphics controller includes a memory and a contrast adjustment module. The memory is configured to store a histogram table for a digital image. The contrast adjustment module is configured to read the histogram table stored in the memory and compute a histogram stretching transfer function based on the read histogram table. The contrast adjustment module is further configured to apply the computed histogram stretching transfer function to digital image data to be subsequently received by the contrast adjustment module.

In another embodiment, a contrast adjustment module of a graphics controller is disclosed. The contrast adjustment module of the graphics controller includes a stretching point computation module, a transfer function computation module, a multiplexer, and a comparison module. The stretching point computation module is configured to compute a first stretching point and a second stretching point to be used in performing a histogram stretching operation. Each of the first and second stretching points corresponds to a respective pixel value. The transfer function computation module is configured to compute a portion of a histogram stretching transfer function based on the first and second stretching points and digital image data to be received by the contrast adjustment module. The multiplexer is configured to output a contrast adjusted pixel value according to a select signal to be received by the multiplexer. The multiplexer is further configured to receive as an input the portion of the histogram stretching transfer function as computed by the transfer function computation module. The comparison module is configured to generate the select signal for the multiplexer. The select signal is generated based on the first and second stretching points and the digital image data to be received by the contrast adjustment module.

In another embodiment, a method for operating a graphics controller to adjust contrast of a digital image received from a digital imaging device is disclosed. The method includes operating a contrast adjustment module within the graphics controller to read a histogram table stored in a memory of the graphics controller. Also in the method, the contrast adjustment module is operated to compute a histogram stretching transfer function to be applied to digital image data received from the digital imaging device, wherein the histogram stretching function is based in part on the histogram table read from the memory. An operation is also performed to receive the digital image data at the contrast adjustment module. The contrast adjustment module is then operated to apply the histogram stretching transfer function to the received digital image data. Application of the histogram stretching transfer function to the received digital image data serves to adjust a contrast of a digital image defined by the received digital image data.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1A is an illustration showing an exemplary histogram for an image having even contrast;

FIG. 1B is an illustration showing an exemplary histogram for an image having low contrast;

FIG. 2A shows an original histogram exhibiting low contrast characteristics;

FIG. 2B shows the stretched histogram following translation of the stretching points “a” and “b” to pixel values 0 and 255, respectively, of the pixel value range;

FIG. 3A is an illustration showing a transfer function for the original histogram as depicted in FIG. 2A;

FIG. 3B is an illustration showing a transfer function for the stretched histogram as depicted in FIG. 2B;

FIG. 4 is an illustration showing a digital image processing system;

FIG. 5 is an illustration showing a digital image processing system, in accordance with one embodiment of the present invention;

FIG. 6 is an illustration showing a more detailed view of the contrast adjustment module, in accordance with one embodiment of the present invention; and

FIG. 7 is an illustration showing a flowchart of a method for operating a graphics controller to adjust contrast of a digital image received from a digital imaging device, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

A digital image is created by mapping a captured image onto a grid of picture elements or pixels. Each pixel is assigned a tonal value, i.e., pixel value, that most closely corresponds to a portion of the captured image that the pixel is intended to represent. In digital imaging, the tonal value of the pixel is represented as a binary code defined by a sequence of binary digits. The number of binary digits used to define each tonal value represents a bit depth of the digital image. A larger bit depth corresponds to a larger set of possible tonal values that can be used to define each pixel in the digital image. For example, in a black and white image having a bit depth of 1 there are (2¹) or 2 possible tonal values that can be assigned to each pixel. In a gray scale or color image having a bit depth of 8 there are (2⁸) or 256 possible tonal values available for assignment to each pixel. Furthermore, an image having a bit depth of 16 will have (2¹⁶) or 65536 possible tonal values for each pixel. It should be appreciated that the present invention can be implemented in conjunction with any bit depth, including bit depths not explicitly identified herein.

The tonal values used to define a digital image can also be used to evaluate properties of the digital image such as contrast. For example, a digital image that includes a large number of pixels having the same or similar tonal value may be identified as having low contrast, thus resulting in obscuring of features or details within the image. Information obtained from analyzing the tonal values of the digital image can be used to refine/improve the image properties prior to display.

One approach for analyzing the tonal values of the digital image is to develop a histogram table for the image, wherein the histogram table represents a frequency of occurrence of each possible tonal value in the image. In the histogram table, a tally is generated for each possible tonal value based on the bit depth of the digital image. Each tally represents a frequency of occurrence of its corresponding tonal value in the digital image. Thus, each pixel in the digital image having a particular tonal value will contribute one count to the tally for the particular tonal value. Once each pixel in the digital image is appropriately tallied into the histogram table, the histogram table can be evaluated to identify contrast issues and improve the image as necessary prior to display.

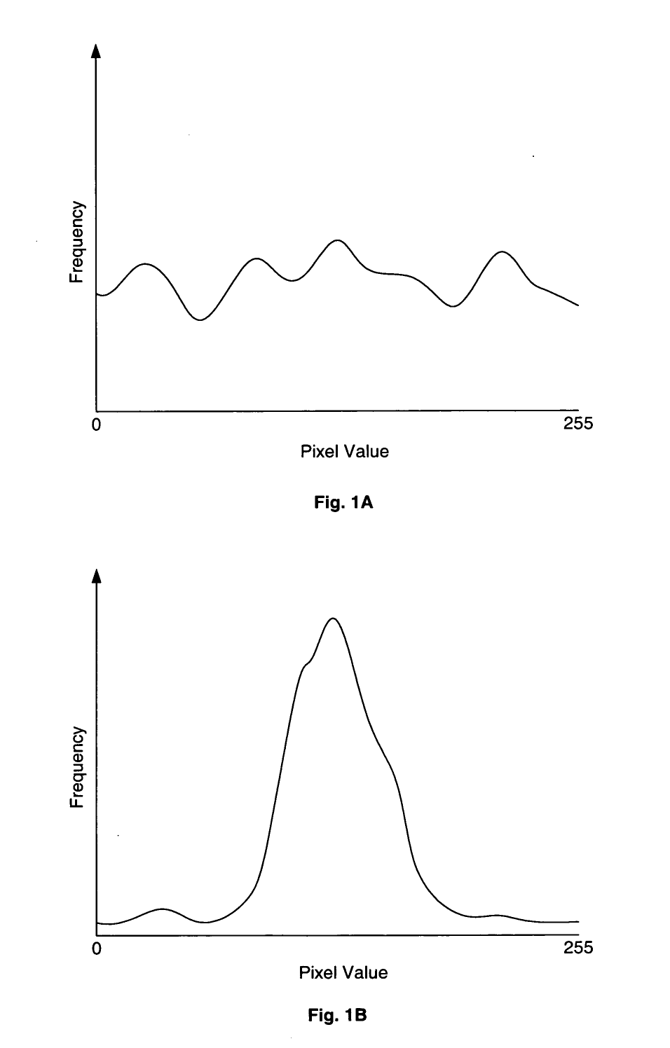

FIG. 1A is an illustration showing an exemplary histogram for an image having substantially even contrast. The image corresponding to the histogram of FIG. 1A has a bit depth of 8. Therefore, (2⁸) or 256 possible tonal values exist for the pixels defining the image. The possible tonal values, i.e., pixel values, are represented as 0 through 255 on the horizontal axis. The vertical axis represents the frequency of occurrence of each pixel value within the image. The histogram of FIG. 1A demonstrates that a broad range of possible pixel values are well-represented in the image. Therefore, the histogram of FIG. 1A does not suggest that the image exhibits a low contrast characteristic.

FIG. 1B is an illustration showing an exemplary histogram for an image having low contrast. As with FIG. 1A, the image of FIG. 1B has a bit depth of 8, with 256 possible tonal values represented as 0 through 255 on the horizontal axis. The vertical axis represents the frequency of occurrence of each pixel value within the image. As demonstrated by the histogram of FIG. 1B, an image having low contrast can have many pixel values that are used infrequently or not at all. Therefore, a majority of the image is represented by pixel values that are closely related, i.e., closely colored. Hence, an observer viewing an image having a majority of pixel values that are closely related may have difficulty resolving details within the image. The peaked behavior of the histogram of FIG. 1B suggests that the image exhibits a low contrast characteristic.

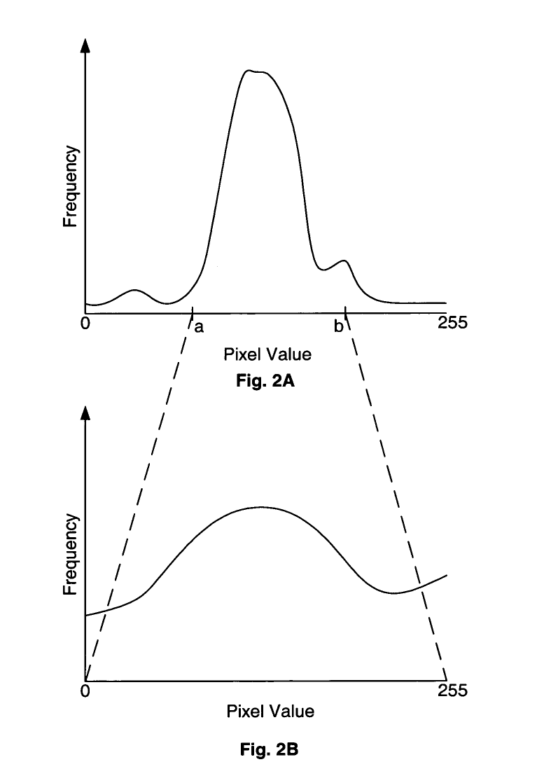

One approach for improving the contrast of an image is to implement a histogram stretching technique on the pixel values defining the digital image. In the histogram stretching technique, two stretching points are chosen within an original histogram and stretched to the minimum and maximum limits, respectively, of the available pixel value range. FIGS. 2A and 2B are illustrations showing the histogram stretching technique, in accordance with one embodiment of the present invention. FIG. 2A shows an original histogram exhibiting low contrast characteristics. In FIG. 2A, two stretching points, “a” and “b” are chosen for implementation of the histogram stretching technique. The two stretching points, “a” and “b”, represent pixel values of the original histogram that will be translated to the minimum and maximum limits, respectively, of the pixel value range, as indicated by the dashed lines connecting FIGS. 2A and 2B.

FIG. 2B shows the stretched histogram following translation of the stretching points “a” and “b” to pixel values 0 and 255, respectively, of the pixel value range. Each of FIGS. 2A and 2B correspond to an image having a bit depth of 8. Therefore, the minimum and maximum limits of the pixel value range are represented by 0 and 255, respectively. In addition to selection and translation of the stretching points “a” and “b”, the histogram stretching technique also utilizes a stretching transfer function to translate, i.e., map, each pixel value in the original histogram to an appropriate pixel value in the stretched histogram.

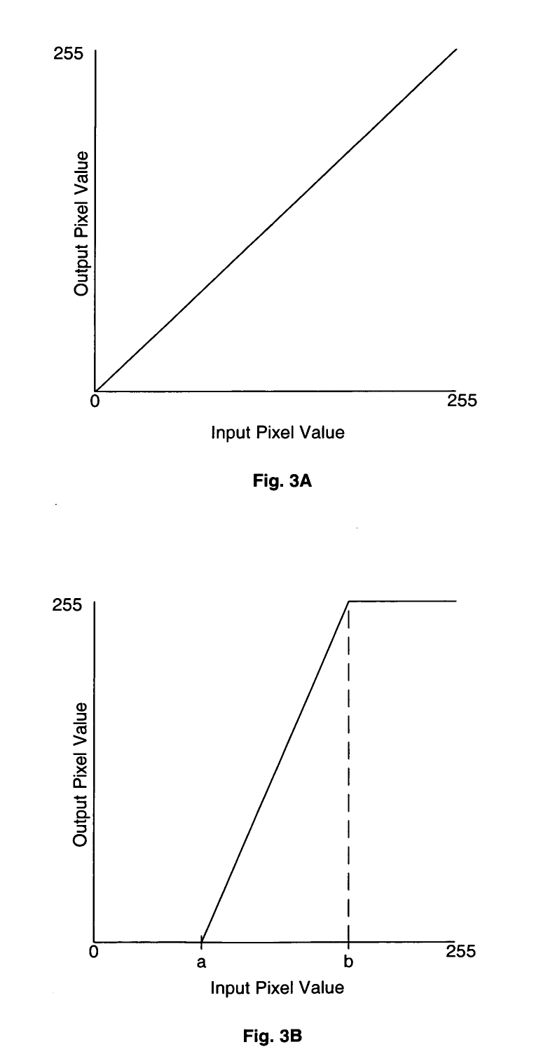

FIG. 3A is an illustration showing a transfer function for the original histogram as depicted in FIG. 2A. The transfer function defines an output pixel value as a function of an input pixel value. Therefore, the transfer function effectively maps each input pixel value to an appropriate output pixel value based on some predefined criteria. Since FIG. 3A corresponds to the original histogram, each output pixel value is equivalent to each input pixel value. Hence, the transfer function for the original histogram is simply represented as a line having a slope of one and extending from pixel value 0 to pixel value 255.

FIG. 3B is an illustration showing a transfer function for the stretched histogram as depicted in FIG. 2B. The transfer function of FIG. 3B shows the stretching points “a” and “b” as being mapped to the minimum (0) and maximum (255), respectively, limits of the pixel value range. The transfer function depicted in FIG. 3B maps each pixel value less than the pixel value corresponding to stretching point “a” to the minimum limit (0) of the pixel value range. Also, the transfer function depicted in FIG. 3B maps each pixel value greater that the pixel value corresponding to the stretching point “b” to the maximum limit (255) of the pixel value range. Furthermore, the transfer function of FIG. 3B maps each pixel value between the pixel values corresponding to stretching points “a” and “b” to an appropriate output pixel value between 0 and 255.

With respect to FIG. 2A, a stretching pixel value range is defined between stretching points “a” and “b”. A percentage of the stretching pixel value range resides between stretching point “a” and each input pixel value within the stretching pixel value range. The transfer function of FIG. 3B is defined such that the percentage of the stretching pixel value range residing between stretching point “a” and a particular input pixel value, within the stretching pixel value range extending from “a” to “b”, will be represented in the stretched histogram between pixel value 0 and the output pixel value, relative to the total pixel value range of the stretched histogram. Therefore, the exemplary transfer function described with respect to FIGS. 2A, 2B, 3A, and 3B can be represented mathematically as follows:

$$Equation 1.$$

$$\begin{matrix}Output \\ Pixel Value\end{matrix} = \{ \begin{matrix}0 , & \begin{matrix}for Input Pixel \\ Value < a\end{matrix} \\ \frac{\begin{matrix}255 \\ ( Input Pixel Value - a )\end{matrix}}{b - a} & \begin{matrix}for a \leq Input \\ Pixel Value \leq b\end{matrix} \\ 255 , & \begin{matrix}for Input Pixel \\ Value > b\end{matrix}\end{matrix}$$

where a and b represent the pixel values corresponding to stretching points “a” and “b”, respectively.

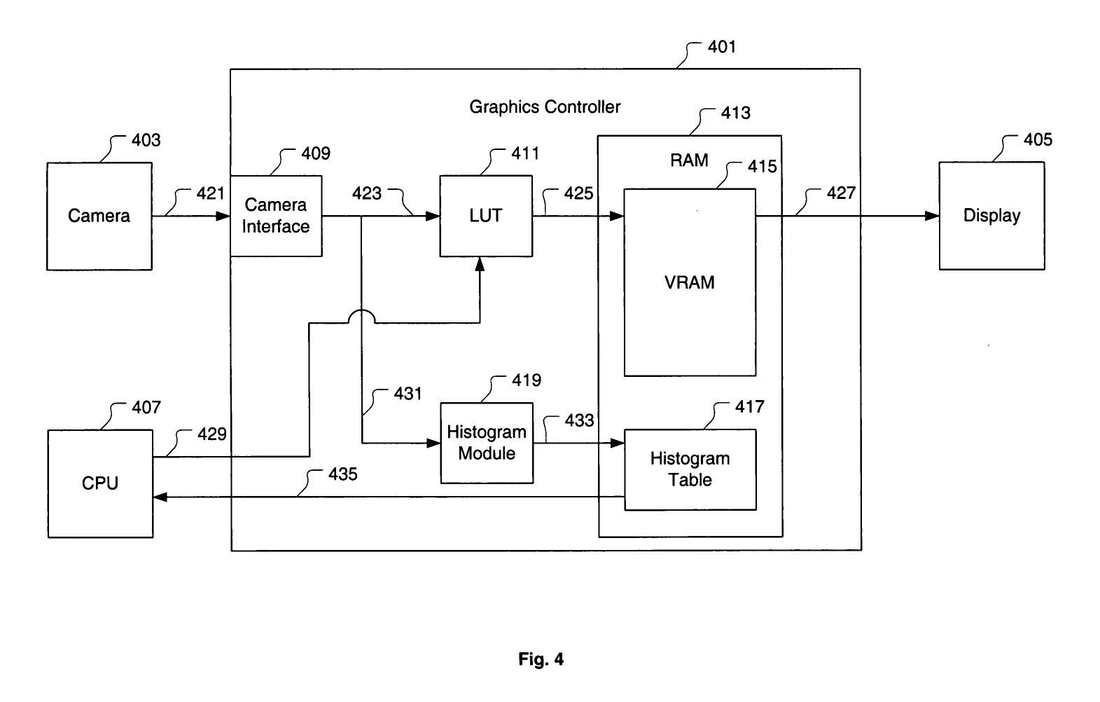

FIG. 4 is an illustration showing a digital image processing system. The processing system includes a camera 403, a graphics controller 401, a central processing unit (CPU) 407, and a display 405. It should be appreciated that the camera 403 can be a digital camera, a digital video camera, or any other device capable of capturing images in a digital format. Also, it should be appreciated that the display 405 can be any type of display device capable of rendering an image defined by electronic signals, e.g., a liquid crystal display (LCD), a plasma display, a cathode ray tube (CRT) display, etc. The CPU 407 represents a generalized host device CPU. It should be appreciated that the graphics controller 401 can be implemented in a host device to provide the host device with digital image processing capability.

The graphics controller 401 includes a camera interface 409, a random access memory (RAM) 413, and histogram module 419. The camera interface 409 is configured to receive digital image data from the camera 403 as indicated by arrow 421. Digital image data from the camera 403 enters the camera interface 409 as a stream of bytes. In one embodiment, the digital image data arrives at the camera interface 409 in pixel order according to a raster sequence. The digital image data arriving at the camera interface 409 can represent streaming video from a digital video camera or a single snapshot from a digital camera. In the case of streaming video, each arriving frame of video can be considered as a single digital image, similar to the single snapshot arriving from the digital camera. Since the histogram table is generated on a single digital image basis, the present invention is described in terms of receiving and processing data for a single digital image. However, it should be understood that the present invention can be implemented with both streaming video and snapshot images.

As previously mentioned, it may be necessary to refine the digital image prior to transmission to the display 405 for viewing. The histogram module 419 provides functionality necessary to generate the histogram table to be used for evaluating the contrast of the digital image. During operation, a histogram table can be generated for each incoming digital image or for selected incoming digital images. Whenever a histogram is to be generated for an incoming digital image, the digital image data is transmitted from the camera interface 409 to the histogram module 419, as indicated by arrow 431. The histogram module 419 operates to determine the tonal value for each incoming pixel and ensures that the corresponding tonal value tally in a histogram table portion of RAM 417 gets updated accordingly, as indicated by arrow 433.

Once the entirety of the digital image data has been received and processed by the histogram module 419, the CPU 407 can be operated to analyze the histogram table as indicated by arrow 435 to determine appropriate adjustments to digital image data to be received for a subsequent digital image. In one embodiment, the CPU 407 will wait to analyze the histogram table until the entire digital image has been processed and the histogram table is complete.

In one embodiment, a lookup table (LUT) 411 can be implemented between the camera interface 409 and a video RAM (VRAM) 415 portion of the RAM 413. Digital image data from the camera interface 109 can be passed through the LUT 411 en route to the VRAM 415, as indicated by arrows 423 and 425. In one embodiment, the LUT 411 serves to implement a transfer function as previously discussed. Thus, the LUT 411 represents each possible pixel value and serves to map each incoming pixel, i.e., input pixel value, to an appropriate output pixel value. The output pixel values from the LUT 411 are then transmitted to the VRAM 415 in place of their respective incoming pixel value. The transfer function implemented by the LUT 411 is established by the CPU 407, as indicated by arrow 429, based on the results obtained from analyzing the histogram table.

In one digital video embodiment, the CPU 407 does not analyze the histogram table for every frame. For example, the CPU 407 may analyze the histogram table once every 30 frames. Based on the histogram table analysis, the CPU 407 will update the LUT 411 used for adjusting the image to be displayed, e.g., via histogram stretching. The updated LUT 411 values will be applied to each frame to be displayed until the CPU 407 operates to update the LUT 411 again.

In accordance with the foregoing, following arrival at the camera interface 409, the digital image data is modified according to the LUT 411 and stored in the VRAM 415. Once the entire digital image, as modified by the LUT 411, is stored in the VRAM 109, the data defining the digital image can be converted into an appropriate electronic format for transmission to the display 405, as indicated by arrow 427. At the display 405, the digital image is rendered for viewing.

In the digital image processing system of FIG. 4, the following operations are performed to implement a histogram stretching technique as previously described:
A histogram is computed in hardware for an incoming digital image and stored in the histogram table portion 417 of RAM 413.
The CPU 407 is operated to read out the histogram table stored in the histogram table portion 417 of RAM 413.
The CPU determines stretching points “a” and “b” based on programmable parameters.
The CPU computes output pixel values of a transfer function defined to perform histogram stretching.
The CPU writes the computed output pixel values for the stretched histogram to appropriate locations in the LUT 411.
The next digital image from the camera interface 409 passes through the LUT 411 before being stored in the VRAM 415, thereby stretching its histogram according to the settings within the LUT 411.

As described above, implementation of the histogram stretching technique using the digital image processing system of FIG. 4 is CPU intensive. Therefore, while the CPU is occupied performing the histogram stretching as described with respect to FIG. 4, other processes that require CPU attention may be delayed. Also, reading the histogram from the histogram table portion 417 of the VRAM 413 and writing the output pixel values to the LUT 411 require toggling of input/output (I/O) lines between the CPU and the graphics controller 401. Toggling of the I/O lines between the CPU and the graphics controller 401 consumes power. Therefore, implementation of the histogram stretching technique using the digital image processing system of FIG. 4 can be costly in terms of CPU bandwidth and power consumption. These CPU bandwidth and power consumption costs can become significant in portable electronic devices, e.g., cell phones, where processing power and battery life are at premiums.

The present invention provides an apparatus that is capable of performing histogram stretching within the graphics controller without reliance on the host CPU and without heavy I/O line toggling between the graphics controller and host CPU. Thus, the present invention offloads processing required for histogram stretching from the host CPU to the graphics controller. Therefore, the present invention frees up the host CPU to perform other tasks and reduces power consumption.

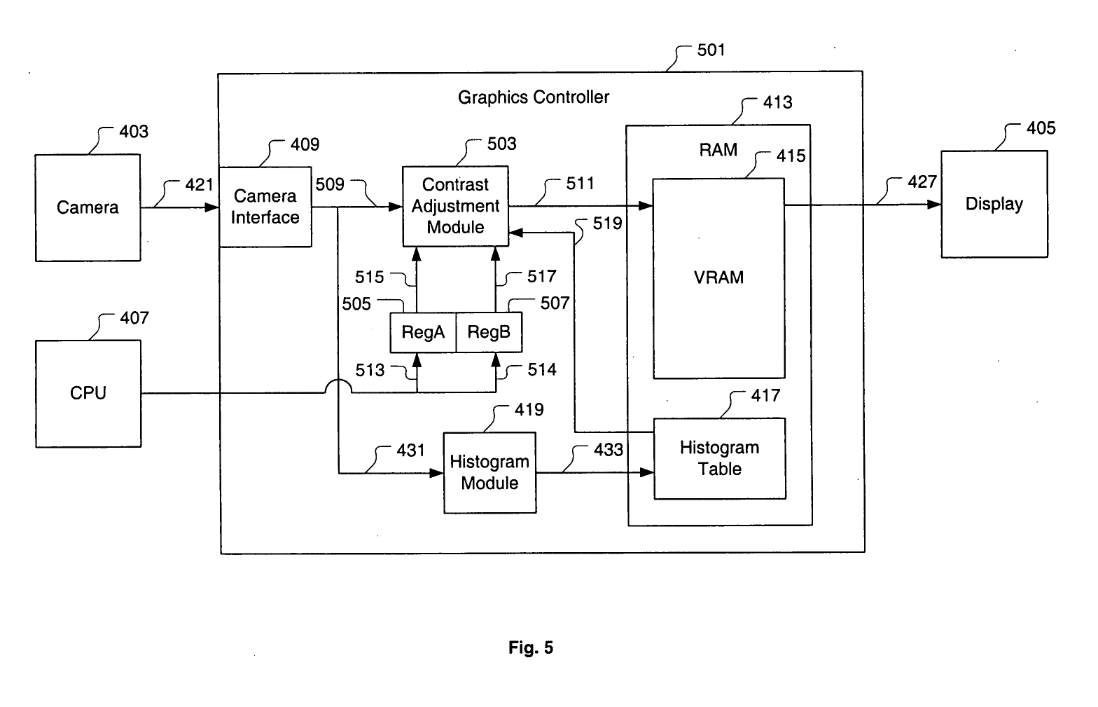

FIG. 5 is an illustration showing a digital image processing system, in accordance with one embodiment of the present invention. As with the processing system of FIG. 4, the processing system of FIG. 5 includes the camera 403, the CPU 407, and the display 405. However, FIG. 5 includes a graphics controller 501 having an internal architecture different from the graphics controller 401 of FIG. 4. More specifically, the graphics controller 501 does not include the LUT 411. Rather, the graphics controller 501 includes a contrast adjustment module 503 having circuitry defined to perform the histogram stretching technique on-board the graphics controller 501. Also, with respect to FIG. 5, it should be appreciated that the camera 403, the camera interface 409, the VRAM 415, the histogram table portion 417 of RAM 413, the histogram module 419, and the display 405 are defined to function in a substantially equivalent manner as previously discussed with respect to FIG. 4.

In the graphics controller 501, the contrast adjustment module 503 receives the incoming digital image data from the camera interface 409 as indicated by arrow 509. The digital image data as modified by the contrast adjustment module 503 is transmitted from the contrast adjustment module 503 to the VRAM 415 as indicated by arrow 511. The contrast adjustment module 501 is also connected to read histogram table data from the histogram table portion 417 of the RAM 413, as indicated by arrow 519. The contrast adjustment module 503 is further connected to read values stored in a first register “RegA” 505 and a second register “RegB” 507, as indicated by arrows 515 and 517, respectively. Values stored in each of RegA 505 and RegB 507 can be set by a user through the host CPU 407 as indicated by arrows 513 and 514, respectively. It should be noted that the host CPU 407 involvement with the contrast adjustment operations of the graphics controller 501 is limited to enabling the user to set values in each of RegA 505 and RegB 507. The purpose of RegA 505 and RegB 507 with respect to the histogram stretching function of the contrast adjustment module 503 will be further described below. It should be appreciated that the registers RegA 505 and RegB 507 can reside at essentially any location within the graphics controller 501, as necessary to optimize the graphics controller 501 layout. For example, the registers RegA 505 and RegB 507 can be located in a register block of the graphics controller 501 or within the contrast adjustment module 503.

In one embodiment, the contrast adjustment module 503 is defined to implement the histogram stretching technique using the transfer function as previously described with respect to FIGS. 2A, 2B, 3A, 3B, and Equation 1. Therefore, the contrast adjustment circuitry 503 requires the two stretching points “a” and “b” and the histogram data from a previous digital image to compute the transfer function to be applied to each pixel value of a subsequent incoming digital image.

Since the nature of the histogram associated with an image to be received from the camera is not known, the stretching points “a” and “b” are difficult to specify explicitly in a fixed manner. In other words, the stretching points “a” and “b” are dependent on the nature of the histogram associated with a particular image. The registers RegA 505 and RegB 507 are provided to assist in computing the stretching points “a” and “b”, respectively. Recalling that the histogram represents a frequency of occurrence of each possible pixel value in the digital image, the total area under the histogram curve represents the total number of pixels in the digital image. In one embodiment, the register RegA 505 is programmed with a value corresponding to a total number of pixels under the histogram curve to be allowed between the minimum possible pixel value, e.g., 0, and the stretching point “a”. In the same embodiment, the register RegB 507 is programmed with a value corresponding to a total number of pixels under the histogram curve to be allowed between the stretching point “b” and the maximum possible pixel value, e.g., 255 in an image having a bit depth of 8. In an exemplary embodiment, the values programmed into RegA 505 and RegB 507 can be defined such that a sum of the number of pixels less than the stretching point “a” and greater than the stretching point “b” corresponds to about 10% of the total number of pixels in the image, i.e., the total number of pixels under the entirety of the histogram curve. It should be appreciated, however, that an essentially limitless number of conditions can be used for determining values to be programmed into RegA 505 and RegB 507. Nevertheless, the values stored in RegA 505 and RegB 507 of the present invention represent criteria that can be used by the contrast adjustment module 503 to compute the stretching points “a” and “b” to be used in implementing the transfer function for histogram stretching.

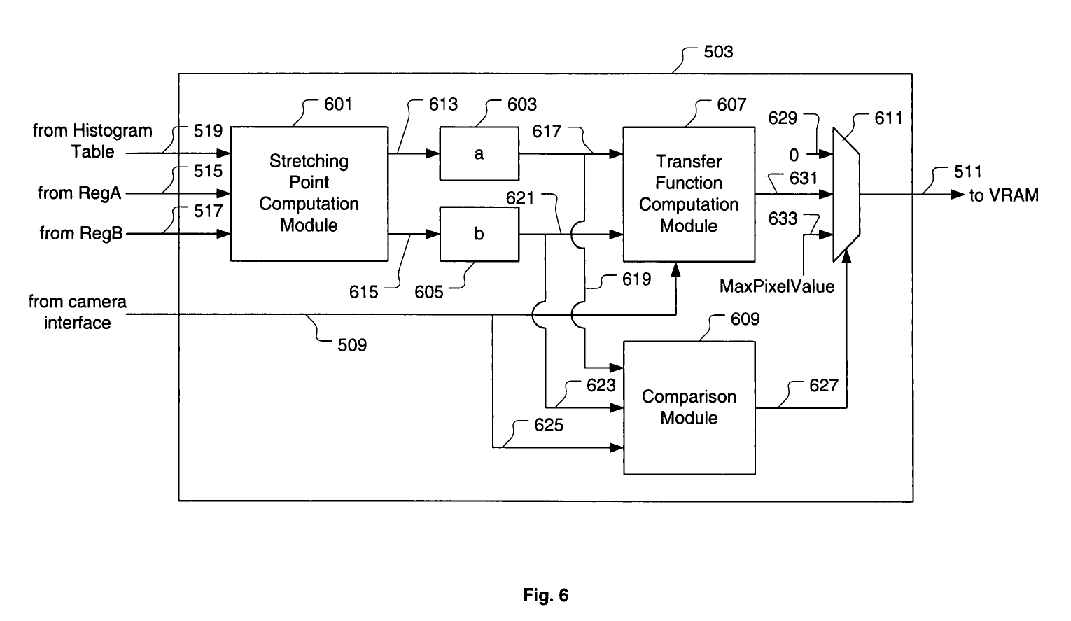

FIG. 6 is an illustration showing a more detailed view of the contrast adjustment module 503, in accordance with one embodiment of the present invention. As indicated by arrows 519, 515, and 517, respectively, the contrast adjustment module 503 is connected to receive input from the histogram table portion 417 of the RAM 413, the register RegA 505, and the register RegB 507. Each of the aforementioned inputs are received into a stretching point computation module 601 which serves to compute the stretching points “a” and “b”.

The stretching point computation module 601 represents circuitry defined to implement an algorithm for computing the stretching points “a” and “b”. The following pseudocode describes an algorithm for computing the stretching point “a”, in accordance with one embodiment of the present invention:

i=0
sum = 0
repeat until (sum > RegA)

read HistogramTable(i)
sum = sum + HistogramTable(i)
i = i + 1

end repeat
a = i − 1

In the above pseudocode, the parameter “i” represents an index counter for the pixel value. The parameter “sum” refers to the sum of pixels represented by the histogram from pixel value 0 through the current pixel value corresponding to the index “i”. The parameter “RegA” corresponds to the value stored in the register RegA 505 on the graphics controller 501. The parameter HistogramTable(i) represents the histogram data as read from the histogram table portion 417 of the RAM 413. The parameter “a” represents the pixel value corresponding to the stretching point “a”.

The following pseudocode describes an algorithm for computing the stretching point “b”, in accordance with one embodiment of the present invention:

i = MaxPixelValue
sum = 0
repeat until (sum > RegB)

read HistogramTable(i)
sum = sum + HistogramTable(i)
i = i − 1

end repeat
b = i + 1

In the above pseudocode, the parameter “i” represents an index counter for the pixel value. The parameter “MaxPixelValue” corresponds to the maximum possible pixel value. For example, an image having a bit depth of 8 will have a MaxPixelValue of 255. The parameter “sum” refers to the sum of pixels represented by the histogram from MaxPixelValue through the current pixel value corresponding to the index “i”. The parameter “RegB” corresponds to the value stored in the register RegB 507 on the graphics controller 501. The parameter HistogramTable(i) represents the histogram data as read from the histogram table portion 417 of the RAM 413. The parameter “b” represents the pixel value corresponding to the stretching point “b”.

The stretching point “a” as calculated by the stretching point computation module 601 is written to a register “a” 603, as indicated by arrow 613. Similarly, the stretching point “b” as calculated by the stretching point computation module 601 is written to a register “b” 605, as indicated by arrow 615. The values stored in registers “a” 603 and “b” 605 are communicated to a transfer function computation module 607 as indicated by arrows 617 and 621, respectively. Also, the values stored in registers “a” 603 and “b” 605 are further communicated to a comparison module 609 as indicated by arrows 619 and 623, respectively.

The transfer function computation module 607 and the comparison module 609 represent circuitry defined to implement the transfer function as previously described with respect to FIGS. 2A, 2B, 3A, 3B, and Equation 1. Each of the transfer function computation module 607 and the comparison module 609 are connected to receive the digital image data incoming from the camera interface 409, as indicated by arrows 509 and 625, respectively. The transfer function computation module 607 is configured to evaluate the following expression:

$$\frac{MaxPixelValue ( InputPixelValue - a )}{b - a}$$

wherein “MaxPixelValue” corresponds to the maximum possible pixel value, “InputPixelValue” corresponds to the pixel value currently received from the camera interface 409, “a” corresponds to the stretching point “a” pixel value as stored in register “a” 603, and “b” corresponds to the stretching point “b” pixel value as stored in register “b” 605. The value calculated by the transfer function computation module 607 is communicated to a multiplexer 611, as indicated by arrow 631.

The comparison module 609 is configured to evaluate the following three conditional expressions and generate an output signal based on the conditional expression that is true:
[InputPixelValue<a] Expression 1:
[a≦InputPixelValue≦b] Expression 2:
[InputPixelValue>b] Expression 3:
wherein “InputPixelValue” corresponds to the pixel value currently received from the camera interface 409, “a” corresponds to the stretching point “a” as stored in register “a” 603, and “b” corresponds to the stretching point “b” as stored in register “b” 605. The output signal generated by the comparison module 609 is communicated as a select signal to the multiplexer 611, as indicated by arrow 627. Since the three conditional expressions evaluated by the comparison module 609 represent three possible outputs, the output signal generated by the comparison module 609 can be defined as a 2-bit signal.

The multiplexer 611 functions to output one of three input values based on the select signal received from the comparison module 609. As previously mentioned, the output from the transfer function computation module 607 represents one of the three inputs to the multiplexer 611, as indicated by arrow 631. A pixel value of 0 is defined as another of the three inputs to the multiplexer 611, as indicated by arrow 629. The MaxPixelValue parameter is the last of the three inputs to the multiplexer 611, as indicated by arrow 633. If the select signal indicates that the expression [InputPixelValue<a] is true, the multiplexer 611 output will correspond to the input pixel value 0. If the select signal indicates that the expression [a≦InputPixelValue≦b] is true, the multiplexer 611 output will correspond to the input as received from the transfer function computation module 607. If the select signal indicates that the expression [InputPixelValue>b] is true, the multiplexer 611 output will correspond to the input MaxPixelValue. The output of the multiplexer 611 is transmitted to the VRAM 511, as indicated by arrow 511.

It should be appreciated that with the digital image processing system of FIGS. 5 and 6, a histogram stretching transfer function can be implemented directly in hardware, i.e., circuitry, thus eliminating the need for a LUT. Removal of the LUT can provide savings in both power and valuable chip space. It should be further appreciated that the contrast adjustment module 503, as described with respect to FIGS. 5 and 6, is responsible for performing the contrast adjustment functions. Therefore, the contrast adjustment module 503 on-board the graphics controller 501 frees up the host CPU 407 to perform tasks other than contrast adjustment, thus increasing an availability of the host CPU 407. Furthermore, the digital image processing system of FIGS. 5 and 6 saves power by reducing a required amount of I/O pin toggling and also by reducing a required number of read operations from the histogram table portion 417 of RAM 413. More specifically, the digital image processing system of FIGS. 5 and 6 does not require the entire histogram table to be read from memory in order to determine stretching points “a” and “b”. Additionally, the digital image processing system of FIGS. 5 and 6 can be utilized to implement essentially any transfer function defined to adjust an incoming digital image through mapping of pixel values. For example, a transfer function to invert colors of an incoming digital image can be implemented using the digital image processing system of FIGS. 5 and 6.

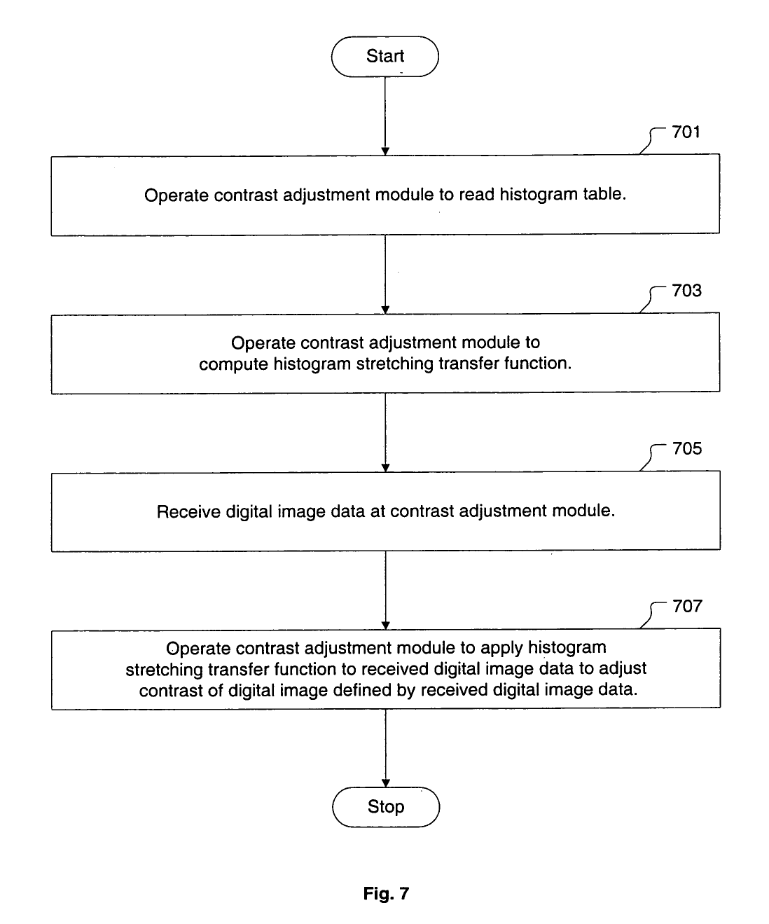

FIG. 7 is an illustration showing a flowchart of a method for operating a graphics controller to adjust contrast of a digital image received from a digital imaging device, in accordance with one embodiment of the present invention. The method includes an operation 701 in which a contrast adjustment module within the graphics controller is operated to read a histogram table stored in a memory of the graphics controller. The method also includes an operation 703 in which the contrast adjustment module is operated to compute a histogram stretching transfer function to be applied to digital image data received from the digital imaging device, wherein the histogram stretching function is based in part on the histogram table read from the memory of the graphics controller.

Operating the contrast adjustment module to compute the histogram stretching transfer function includes calculating a first stretching point and a second stretching point, wherein each of the first and second stretching points corresponding to a respective pixel value. The first stretching point is computed based on a number of pixels in the digital image to be allowed between a minimum possible pixel value and the first stretching point. The second stretching point is computed based on a number of pixels in the digital image to be allowed between the second stretching point and a maximum possible pixel value.

Operating the contrast adjustment module to compute the histogram stretching transfer function further includes determining a histogram stretching transfer function value corresponding to a pixel value greater than or equal to the first stretching point and less than or equal to the second stretching point. In one embodiment, the expression previously discussed with respect to Equation 1 can be implemented to determine the histogram stretching transfer function value corresponding to the pixel value greater than or equal to the first stretching point and less than or equal to the second stretching point.

The method further includes an operation 705 for receiving digital image data at the contrast adjustment module, wherein the digital image data defines the digital image to which contrast adjustment is to be performed. Additionally, the method includes an operation 707 in which the contrast adjustment module is operated to apply the histogram stretching transfer function to the received digital image data. Each pixel value within the digital image data that is received by the contrast adjustment module is compared to the first and second stretching points to determine an appropriate histogram stretching transfer function value. Then, the appropriate histogram stretching transfer function value is output by the contrast adjustment module in place of the received pixel value. Application of the histogram stretching transfer function to the received digital image data serves to adjust the contrast of the corresponding digital image.

The apparatus and method of the present invention can be particularly useful when implemented in portable electronic devices where processing power is at a premium. Some portable electronic devices that can benefit from the present invention include digital cameras, digital video recorders, digital camera or video enabled cell phones, and other handheld devices having digital imaging capability.

With the above embodiments in mind, it should be understood that the present invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations. Also, any of the operations described herein that form part of the invention can be performed by any suitable structural “means” that provide capability for performing the recited functionality. For instance, example structure is provided by way of the structural components described in the various embodiment of the claimed invention.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

1. A graphics controller, comprising:
a memory configured to store a histogram table for a digital image; and
a contrast adjustment module configured to read the histogram table stored in the memory, the contrast adjustment module being further configured to compute a histogram stretching transfer function based on the read histogram table and apply the computed histogram stretching transfer function to digital image data to be subsequently received by the contrast adjustment module.

2. A graphics controller as recited in claim 1, wherein the contrast adjustment module is configured to compute and apply the histogram stretching function without involvement of a processor of a host device of the graphics controller.

3. A graphics controller as recited in claim 1, wherein the contrast adjustment module is configured to compute the histogram stretching transfer function without reading an entirety of the histogram table stored in the memory.

4. A graphics controller as recited in claim 1, wherein the contrast adjustment module is configured to compute and apply the histogram stretching transfer function on a pixel-by-pixel basis to each pixel represented within the digital image data to be subsequently received by the contrast adjustment module.

5. A graphics controller as recited in claim 1, wherein the histogram stretching transfer function is computed and applied by the contrast adjustment module without requiring storage of the computed histogram stretching transfer function prior to application of the computed histogram stretching transfer function.

6. A graphics controller as recited in claim 1, further comprising:
a camera interface configured to transmit incoming digital image data to the contrast adjustment module; and
an image portion of the memory configured to receive digital image data from the contrast adjustment module and store the digital image data received from the contrast adjustment module,
wherein the contrast adjustment module is configured to compute and apply the computed histogram stretching transfer function to the digital image data during transmission of the digital image data from the camera interface through the contrast adjustment module to the image portion of the memory.

7. A contrast adjustment module of a graphics controller, comprising:
a stretching point computation module configured to compute a first stretching point and a second stretching point to be used in performing a histogram stretching operation, each of the first and second stretching points corresponding to a respective pixel value;
a transfer function computation module configured to compute a portion of a histogram stretching transfer function based on the first and second stretching points and digital image data to be received by the contrast adjustment module;
a multiplexer configured to output a contrast adjusted pixel value according to a select signal to be received by the multiplexer, the multiplexer being further configured to receive as an input the portion of the histogram stretching transfer function as computed by the transfer function computation module; and
a comparison module configured to generate the select signal for the multiplexer, the select signal being generated based on the first and second stretching points and the digital image data to be received by the contrast adjustment module.

8. A contrast adjustment module of a graphics controller as recited in claim 7, wherein the first stretching point is computed based on a number of pixels in the digital image to be allowed between a minimum possible pixel value and the first stretching point, the second stretching point being computed based on a number of pixels in the digital image to be allowed between the second stretching point and a maximum possible pixel value.

9. A contrast adjustment module of a graphics controller as recited in claim 8, wherein the contrast adjustment module is connected to read values stored in a first register and a second register, the first register allocated to store the number of pixels in the digital image to be allowed between the minimum possible pixel value and the first stretching point, the second register allocated to store the number of pixels in the digital image to be allowed between the second stretching point and a maximum possible pixel value.

10. A contrast adjustment module of a graphics controller as recited in claim 9, wherein values stored in the first and second registers are set such that a sum of the number of pixels in the digital image between the minimum possible pixel value and the first stretching point and between the second stretching point and a maximum possible pixel value corresponds to 10% of a total number of pixels in the digital image.

11. A contrast adjustment module of a graphics controller as recited in claim 7, wherein the portion of the histogram stretching function corresponds to pixel values greater than or equal to the first stretching point and less than or equal to the second stretching point.

12. A contrast adjustment module of a graphics controller as recited in claim 7, wherein the portion of the histogram stretching function is defined as
$$\frac{MaxPixelValue ( InputPixelValue - a )}{b - a} ,$$
wherein MaxPixelValue is the maximum possible pixel value, InputPixelValue is a pixel value within the digital image data to be received by the contrast adjustment module, a is the pixel value corresponding to the first stretching point, and b is the pixel value corresponding to the second stretching point.

13. A contrast adjustment module of a graphics controller as recited in claim 7, wherein the contrast adjusted pixel value output by the multiplexer corresponds to either the minimum possible pixel value, the portion of the histogram stretching transfer function as computed by the transfer function computation module, or the maximum possible pixel value.

14. A contrast adjustment module of a graphics controller as recited in claim 7, wherein the select signal is defined to direct the multiplexer to output the minimum possible pixel value when a pixel value within the digital image data is less than the first stretching point, the select signal being defined to direct the multiplexer to output the portion of the histogram stretching transfer function as computed by the transfer function computation module when the pixel value within the digital image is greater than or equal to the first stretching point and less than or equal to the second stretching point, the select signal being defined to direct the multiplexer to output the maximum possible pixel value when the pixel value within the digital image is greater than the second stretching point.

15. A method for operating a graphics controller to adjust contrast of a digital image received from a digital imaging device, comprising:
operating a contrast adjustment module within the graphics controller to read a histogram table stored in a memory of the graphics controller;
operating the contrast adjustment module to compute a histogram stretching transfer function to be applied to digital image data received from the digital imaging device, the histogram stretching function being based in part on the histogram table read from the memory;
receiving the digital image data at the contrast adjustment module; and
operating the contrast adjustment module to apply the histogram stretching transfer function to the received digital image data, wherein application of the histogram stretching transfer function to the received digital image data serves to adjust a contrast of a digital image defined by the received digital image data.

16. A method for operating a graphics controller to adjust contrast of a digital image to be received from a digital imaging device as recited in claim 15, wherein operating the contrast adjustment module to compute the histogram stretching transfer function includes calculating a first stretching point and a second stretching point, each of the first and second stretching points corresponding to a respective pixel value.

17. A method for operating a graphics controller to adjust contrast of a digital image to be received from a digital imaging device as recited in claim 16, wherein the first stretching point is computed based on a number of pixels in the digital image to be allowed between a minimum possible pixel value and the first stretching point, the second stretching point being computed based on a number of pixels in the digital image to be allowed between the second stretching point and a maximum possible pixel value.

18. A method for operating a graphics controller to adjust contrast of a digital image to be received from a digital imaging device as recited in claim 16, wherein operating the contrast adjustment module to compute the histogram stretching transfer function includes determining a histogram stretching transfer function value corresponding to a pixel value greater than or equal to the first stretching point and less than or equal to the second stretching point.

19. A method for operating a graphics controller to adjust contrast of a digital image to be received from a digital imaging device as recited in claim 18, wherein the histogram stretching transfer function value corresponding to the pixel value greater than or equal to the first stretching point and less than or equal to the second stretching point is defined as
$$\frac{MaxPixelValue ( InputPixelValue - a )}{b - a} ,$$
wherein MaxPixelValue is a maximum possible pixel value, InputPixelValue is a pixel value within the digital image data received by the contrast adjustment module, a is the pixel value corresponding to the first stretching point, and b is the pixel value corresponding to the second stretching point.

20. A method for operating a graphics controller to adjust contrast of a digital image to be received from a digital imaging device as recited in claim 16, wherein operating the contrast adjustment module to compute the histogram stretching transfer function includes comparing the pixel value within the digital image data received by the contrast adjustment module to the first and second stretching points to determine an appropriate histogram stretching transfer function value to be output by the contrast adjustment module in place of the received pixel value.
